(19) United States
(12) Patent Application Publication
(10) Pub. No.: US 2001/0052932 A1
(43) Pub. Date: Dec. 20, 2001

(54) Digital film processing method and system

(76) Inventors: Robert S. Young JR., Austin, TX (US); Richard D. Ball, Austin, TX (US); G. Gregory Mooty, Austin, TX (US); Marc C. Digby, Austin, TX (US); Christopher P. Hansen, Austin, TX (US); Clyde W. Hinkle II, Austin, TX (US); Jon D. Isom, Austin, TX (US); Philip E. Cannata, Austin, TX (US)

Correspondence Address: David G. Wille, Baker Botts LLP, 2001 Ross Avenue, Dallas, TX, 75201, US

(21) Appl. No.: 09/748,788

(22) Filed: Dec. 22, 2000

Related U.S. Application Data
(60) Provisional application No. 60/173,787, filed on Dec. 30, 1999.
(60) Provisional application No. 60/174,074, filed on Dec. 30, 1999.
(60) Provisional application No. 60/173,781, filed on Dec. 30, 1999.
(60) Provisional application No. 60/174,073, filed on Dec. 30, 1999.
(60) Provisional application No. 60/173,780, filed on Dec. 30, 1999.

(51) Int. Cl. H04N 5/253

(52) U.S. Cl. 348/96

(57) ABSTRACT

One aspect of the invention is a digital film processing system having a first light source operable to illuminate film. The digital film processing system also includes a first sensor operable to produce a first output in response to a first amount of light reflected from the film for a first time interval and a second sensor operable to produce a second output in response to a second amount of light passed through the film for the first time interval. The digital film processing system further includes processing circuitry coupled to the first light source and operable to adjust the output of the first light source in response to the first and second outputs so that the first sensor and the second sensor do not saturate. More particularly, the processing circuitry is further operable to adjust image data obtained from the film in response to the first and second outputs. In a further embodiment, the processing circuitry is further operable to adjust the output of the first light source in response to a film type.

### CROSS REFERENCE TO RELATED APPLICATIONS

This application claims benefit under 35 U.S.C. §119(e) of United States provisional application Ser. No. 60/173,787, entitled Digital Film Processing Method and System, which was filed on Dec. 30, 1999.

This application is related to the following co-pending applications filed on Dec. 30, 1999: Ser. No. 60/174,074, entitled Method and System for Estimating Sensor Dark Current Drift; Ser. No. 60/173,781, entitled Pulsed Illumination Signal Modulation Control and Adjustment; Ser. No. 60/174,073, entitled Digital Film Processing Feature Location Method and System; and Ser. No. 60/173,780, entitled Method and System for Estimating Sensor and Illumination Non-Uniformities.

### TECHNICAL FIELD OF THE INVENTION

This invention relates to image processing and more particularly to a digital film processing method and system.

### BACKGROUND OF THE INVENTION

During the scanning of photographic images from film, various factors may affect the quality of the resulting digital image. For example, systems used to derive digital images from film may suffer from both sensor and illumination drift, each of which may adversely affect the signal integrity of the images. Image quality may also depend, in part, on the characteristics of the film. Where digital image data is obtained from developing film, the characteristics of the developing chemical applied to the film may also affect image quality.

For example, processing images from film typically includes capturing digital data from the film with a sensor as the film is illuminated with a light source. Because the illumination levels captured by the sensor represent the image data, any variances in non-image film characteristics introduce undesirable errors into the data measurements. Where the film is scanned while being developed, additional variances in film and chemical developer characteristics often arise due to changes that take place during the development process. Signal levels captured by the sensors may also vary due to factors such as aging of the sensors or light sources.

In addition, higher illumination levels are desirably used as films become denser because these films result in lower signal to noise ratios in image data. On the other hand, using higher illumination levels with less dense films may result in sensor saturation. As a result, some systems may produce inaccurate data due to improperly saturated sensors, whose signals are not reliable, and do not yield consistent results. These signal levels measured by the sensor may be erroneously interpreted as properly captured data content from the film. To prevent inconsistent results, some systems use ‘fudge factors’ or manual ‘drift’ values to prevent overflow.

### SUMMARY OF THE INVENTION

From the foregoing, it may be appreciated that a need has arisen for providing an improved digital film processing method and system. The present invention substantially reduces or eliminates disadvantages and problems of existing systems.

One aspect of the invention is a digital film processing system having a first light source operable to illuminate film. The digital film processing system also includes a first sensor operable to produce a first output in response to a first amount of light reflected from the film for a first time interval and a second sensor operable to produce a second output in response to a second amount of light passed through the film for the first time interval. The digital film processing system further includes processing circuitry coupled to the first light source and operable to adjust the output of the first light source in response to the first and second outputs so that the first sensor and the second sensor do not saturate. More particularly, the processing circuitry is further operable to adjust image data obtained from the film in response to the first and second outputs. In a further embodiment, the processing circuitry is further operable to adjust the output of the first light source in response to a film type.

The invention provides several important advantages. Various embodiments of the invention may have none, some, or all of these advantages. This advantage may improve the accuracy of image data by, for example, using an unexposed region to match the white level to one or more sensors each associated with a film development time. White level adjustment allows better use of the dynamic range of the sensor, resulting in a more accurate digital representation of the image. In addition, transient responses of devices can be reduced, as can the time for devices to reach a proper operating point. The invention may also generate an alert that illumination and sensor devices should be replaced.

The invention may also utilize additional sensor views to capture data through various incident angles of light, which may substantially improve image quality by preventing overflow of pixel values of image data. The invention may also prevent saturation of sensors in varying film, developer, and illumination conditions. Other technical advantages may be readily ascertainable by those skilled in the art from the following figures, description, and claims.

### BRIEF DESCRIPTION OF THE DRAWINGS

For a more complete understanding of the present invention and the advantages thereof, reference is now made to the following descriptions taken in conjunction with the accompanying drawings in which:

FIG. 1 illustrates an example of a digital film processing system that may be used in accordance with the invention;

FIG. 1A illustrates an example of a cross section of film from which image data may be captured;

FIG. 2 illustrates an example of an image capture engine that comprises an embodiment of the present invention;

FIG. 2A illustrates another example of an image capture engine that comprises another embodiment of the present invention;

FIG. 3 illustrates an example of a method for capturing and adjusting image data in accordance with the present invention;

FIG. 4 graphically illustrates an example of an imaging window during which sensor integration times and/or light source illumination levels may be adjusted in accordance with the present invention;

FIG. 5 illustrates an example of a method for adjusting the dynamic range of an image capture system in accordance with the present invention;

### DETAILED DESCRIPTION OF THE INVENTION

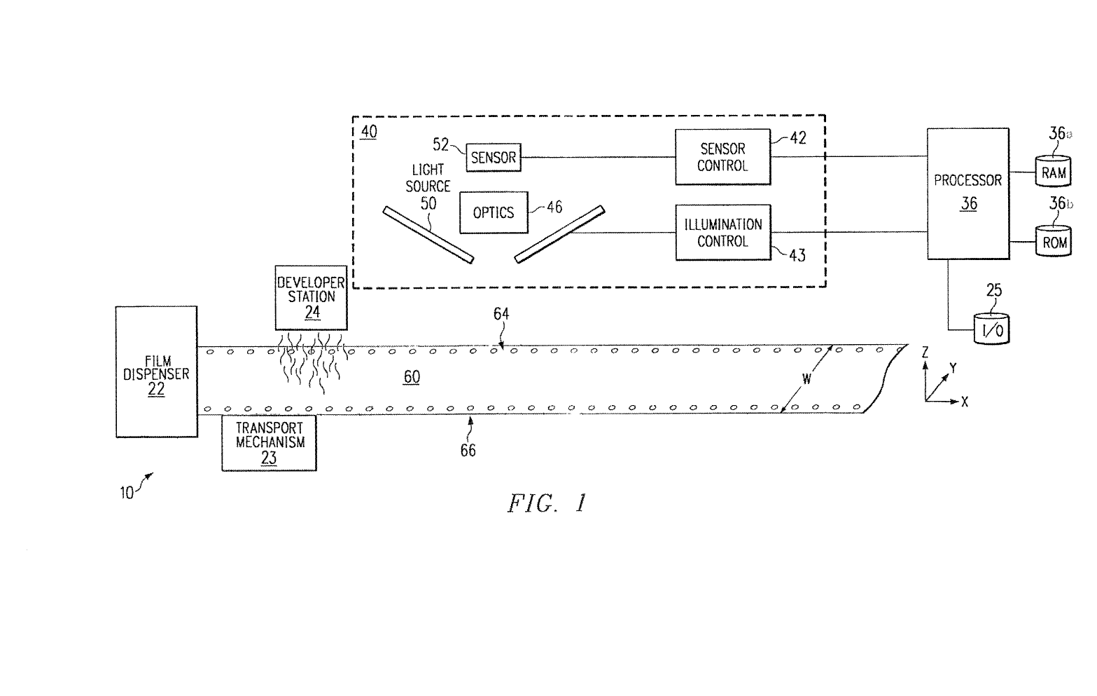

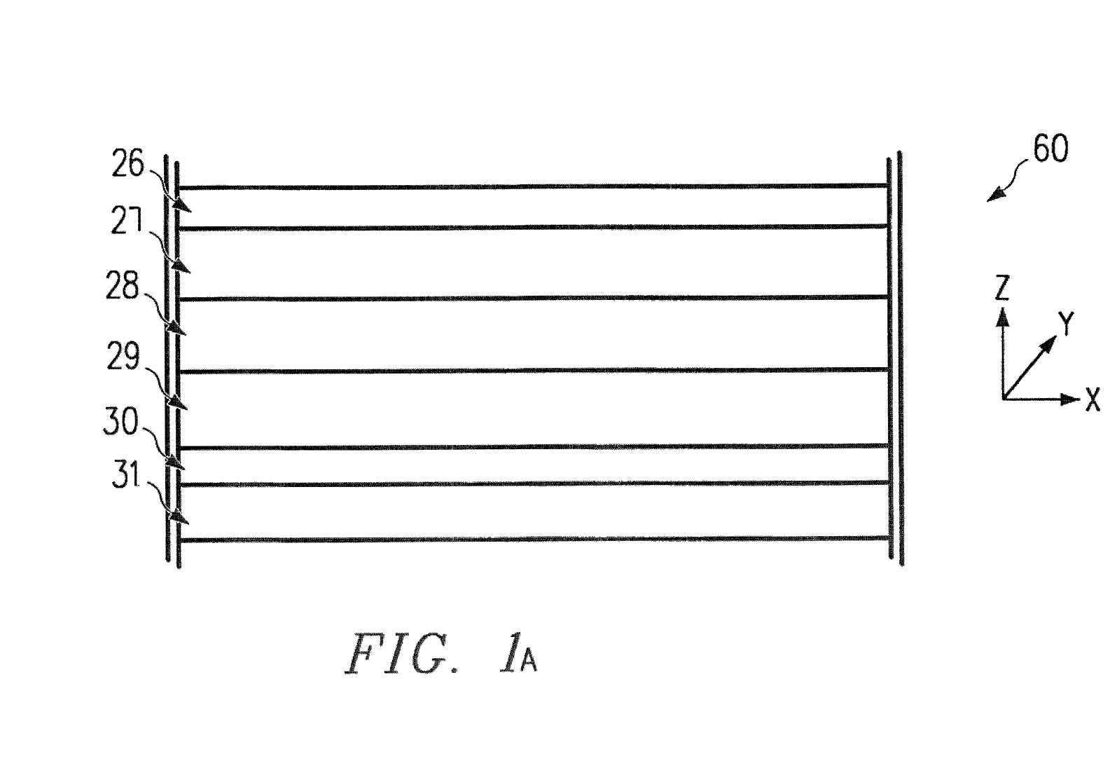

The preferred embodiment of the present invention and its advantages are best understood by referring to FIGS. 1-5 of the drawings, like numerals being used for like and corresponding parts of the various drawings. Because characteristics of film typically affect light differently when illumination originates from a top light source and a bottom light source, a plurality of sensors may be utilized to provide a plurality of sensor views. These views may be used to capture reflective and through transmission paths of illumination from light sources to obtain various aspects of a latent image in the film. These views may be used to prevent saturation at the sensors, and to provide the advantage of capturing additional data to establish a system dynamic range for a digital film processing system, which may improve the accuracy of the image data and thus the signal-to-noise ratio of each digital image. Thus, a digital film processing system may adjust its dynamic range to that of the film by measuring white levels in an unexposed region of film in an effort to accommodate variations in film density and/or image data content. Alternatively, a digital film processing system may adjust its dynamic range to that of the film by measuring white levels from a dry undeveloped region of film in an effort to accommodate variations in film density and/or image data content.

FIG. 1 illustrates an example of a digital film processing system 10 that comprises a film dispenser 22, at least one transport mechanism 23, a developer station 24, a processor 36 and at least one input/output device 25, and at least one sensor station 40. Digital film processing system 10 is operable to capture and/or adjust data captured from a film 60 that is disposed proximate to and/or may move at a scan rate relative to sensor station 40. Digital film processing system 10 may desirably improve the accuracy of captured image data by compensating for fluctuations in a variety of parameters over time.

It may be illustrative to utilize a coordinate system to describe digital film processing system 10. For example, sensor station 40 may be disposed in a z direction proximate to, and may be moved at a scan rate relative to a film 60, operable to store latent image data, such as film. Film 60 may be disposed, for example, in an x-y plane and have a width W in the y direction. By way of example and not by limitation, film 60 may be disposed in a generally vertical orientation, and/or may not be disposed within any single plane, but rather move through a plurality of orientations as sensor station 40 captures image data therefrom. As another example, film 60 may be disposed in a mobius strip configuration so that sensor station 40 may capture image data from top and bottom portions 64 and 66. Sensor station 40 may also be disposed proximate to and oriented in various angles relative to film 60.

At least one sensor station 40 is operable to obtain image data from film 60, even while the film may have developing chemicals applied thereto. In other words, the film may be developing, or may be completely developed. Developer station 24 may be used to apply a thin layer of a developing chemical to film 60. By way of example and not by limitation, developer station 24 may be a slot coater or vibrating dispenser that sprays or otherwise applies the developing chemical to film 60. Transport mechanism 23 may be used to move film 60 at a desired scan rate relative to sensor station 40. Film dispenser 22 may be used to retain film 60 and to guide the film onto transport mechanism 23.

Sensor station 40 may be used to capture image data from film 60 and transfers the image data to an input/output device 25 such as a storage medium. Sensor station 40 comprises optics 46, light source 50, sensor 52, sensor control 42, and illumination control 43. Sensor 52 operates in concert with light source 50 and optics 46 to capture or obtain image data from a film 60 such as film.

Any suitable light source 50 and compatible sensor 52 such as those typically used in image processing applications involving photographic images may be used to capture image data for this aspect of sensor station 40. That is, sensor 52 may be any detector whose quantum efficiency, or responsivity, is compatible with a spectrum utilized by light source 50. For example, where light source 50 comprises mostly infrared or near-infrared energy, or energy outside the visible spectrum, sensor 52 is responsively operational to such wavelengths. Other combinations of light source and sensors may also be used. Other examples may include, but are not limited to, a light source comprising a single column point source coupled to a scan mirror that may be operated in conjunction with a sensor comprising a point detector coupled to the scan mirror.

The light source 50 may comprise one or more devices or system that produces suitable light. In the preferred embodiment, the light source 50 comprises an array of light-emitting diodes (LEDs). In another embodiment, the light source 50 comprises a broad spectrum light source, such as a fluorescent, incandescent, halogen, direct gas discharge lamps, and the like. In this embodiment, filters may be used to produce the suitable frequency, or color, of light. Different colors of light interact differently with the film 60. For example, infrared light interacts with the silver within the film 60, but does not interact with any dye clouds formed in the film 60. Red, green and blue light interacts with the magenta, cyan, and yellow dye clouds within the film 60, respectively. Accordingly, the light produced by the light source 50 depends upon the embodiment. For example, in some embodiments, the light source 50 produces infrared light. In another embodiment, the light source 50 produces light within the visible portion of the electromagnetic spectrum, or visible light. In yet another embodiment, the light source 50 produces a visible and infrared light, either in combination or in series.

In some applications, sensor 52 may comprise a plurality of charge-coupled devices (CCDs), photo diodes, or CMOS sensors. For example, sensor 52 may comprise a digital camera comprising a two-dimensional array of CCDs operable to capture data from a two-dimensional field of view in film 60. Sensor 52 may also comprise a generally linear one-dimensional array, where the array comprises a plurality of detectors such as CCDs. Sensor 52 may also comprise a generally linear array of 4,096 (or any other number) detectors that may be, for example, staggered or linearly aligned within the array. The generally linear array may be operable to capture a data or image column over a generally linear field of view that spans width W (in the y direction) of film 60, or a portion thereof.

Each detector within sensor 52 typically varies in thickness of coating, photo-emissive characteristics, optics, etc., and thus typically varies in responsivity to a given amount of illumination. The responsivity of each detector also varies due to noise, age, and temperature. Such variation in responsivity to illumination within each sensor typically results in spatial non-uniformities in the image data. For example, where sensor 52 comprises a generally linear CCD array, variations in the efficiency of each detector in converting photons to electrons results in variations in illumination levels measured by each detector, regardless of variations in the film 60 and/or content therein.

A system signal-to-noise ratio may be measured by a combination of sensor responsivity and illumination characteristics of each sensor station. This signal-to-noise ratio may be improved by selecting sensor 52 for its sensitivity to intensity and wavelength illumination. Further improvements to the accuracy of captured data, and thus to image quality, may also be obtained by matching captured electron levels in sensor 52 to a full dynamic range for each latent image within film 60. For example, the capacity of wells for each detector, that is, the number of photons it may convert to electrons affects the range of discrete digital levels measurable by each detector, regardless of data content within film 60. Wells within sensor 52 may be desirably sized to be sufficiently large to accommodate desired image signal to noise ratios. In addition, digital film processing system 10 may adjust integration time for sensor 52 and/or adjust the illumination power of light source 50 in order to maximize usage of the capacity of each detector well within sensor 52.

In one embodiment of the invention, light source 50 may be arranged in a wave-guide. Each wave-guide may comprise a plurality of illuminators, such as light emitting diodes (LEDs). Light may travel from light source 50, through the wave-guide, be reflected by film 60, and focused by optics 46 onto sensor 52. Any suitable optics 46 for use with light source 50 and sensor 52 may be used to produce desired optical effects in the image captured by sensor 52. For example, optics 46 may be used to focus, magnify or enlarge data in film 60 to a desired image resolution for an application, such as 12 μm per pixel. Optics 46 and light source 50 may be manually or automatically controlled by, for example, processor 36.

Processor 36 may be used for image data processing and adjustment in accordance with the present invention. Processor 36 may also control the operation of sensor station 40 by using sensor control 42 and/or illumination control 43. Alternatively or in addition, processor 36 may control sensor station 40 by, for example, executing software that may be stored in an input/output device 25 such as a storage medium. Although a single input/output device 25 has been illustrated for simplicity, input/output device 25 may comprise multiple storage media as well as comprising storage media of different types. Moreover, although illustrated as separate units, processor 36 may perform some, none, or all of the logic functions described as being performed within illumination control 43 and/or sensor control 42.

Specifically, processor 36 may be used to execute applications comprising image data processing and adjustment software. Image data processing and adjustment may be performed using special purpose digital circuitry contained either in processor 36, or in a separate device. Such dedicated digital circuitry may include, for example, application-specific integrated circuitry (ASIC), state machines, fuzzy logic, etc. Processor 36 may also comprise a portion of a computer adapted to execute any of the well-known MS-DOS, PC-DOS, OS2, UNIX, MAC-OS and Windows operating systems or other operating systems, including nonconventional operating systems. Processor 36 may comprise random access memory (RAM) 36a and read only memory (ROM) 36b, and may be coupled to one or more input/output devices 25. These devices may include, but are not limited to, printers, disk drives, displays and a communications link. Disk drives may include a variety of types of storage media such as, for example, floppy disk drives, hard disk drives, CD ROM drives, or magnetic tape drives.

Input/output device 25 comprising a communication link may be connected to a computer network, a telephone line, an antenna, a gateway, or any other type of communication link. Image data captured from other than digital film processing system 10 may also be adjusted in accordance with the invention. For example, processor 36 may be coupled to an external network that may be used to obtain image data, such as a scanner or camera system. Captured image data may then be provided to processor 36 from a computer network over the communication link.

The present invention includes programs that may be stored in RAM 36a, ROM 36b, or input/output device 25 such as one or more disk drives, and may be executed by processor 36. In this embodiment, image data adjustment may be performed by software stored and executed by processor 36 with the results stored in an input/output device 25 comprising any suitable storage medium. Image data may be processed as it is obtained, after all data has been captured, or a combination thereof.

Illumination control 43 may be used to control the amount of optical energy given off by light source 50, both in time and/or in amplitude. For example, it may be desirable to adjust the output optical energy from light source 50 if sensor 52 is saturating, or if illumination levels are otherwise determined to be too high or too low. Illumination control 43 may also include additional circuitry used to interface the logic with light source 50.

Sensor control 42 may be used for data transfer and/or processing and to control activation and deactivation of sensor 52. For example, sensor control 42 may convert an analog signal to a digital pixel value, or transfer pixel data stored in sensor 52 where sensor 52 has an internal memory. In some applications, sensor 52 may also comprise logic, such as a programmable processor, that may adjust or process pixel data as desired, before the pixel data is transferred into a memory or storage medium. Such a processor may perform the functions of sensor control 42. In addition, sensor control 42 may also include a bias control to improve system dynamic range. For example, sensors may retain residual charge that decreases the amount of usable sensor capacity. Sensor control 42 may desirably increase the system dynamic range by applying a bias to sensor 52 to reduce the effect of this residual scene content on newly captured image data. Sensor control 42 may comprise software, hardware, or a combination thereof.

Sensor control 42 may also be used to control activation and deactivation of sensor 52, independently of or in conjunction with light source 50. For example, sensor 52 may comprise a mechanical or electronic shutter mechanism for controlling a dwell or integration time in which the sensor may convert a number of photons received into electrons. When light source 50 is activated, sensor 52 integrates over an interval of time signals reflected from film 60. By so controlling a combination of illuminated power and sensor integration time, digital film processing system 10 may adjust an amount of illumination measurable by sensor 52 and thus adjust system dynamic range as desired.

Digital film processing system 10 may obtain data from many kinds of images, such as color photographic images (either negative print or transparency), black and white images (either negative print or transparency and including black and white images derived from photographic film with multiple layers), other monochromatic images, x-rays, or any other type of image stored on film 60. Digital film processing system 10 may capture data from any tangible film 60 that may both reflect back and/or pass through illumination from a light source. One example of film 60 is discussed in conjunction with FIG. 1A.

FIG. 1A illustrates an example of a cross-section of film from which image data may be captured. Where the film 60 is color, it typically comprises three color emulsion layers—e.g., a blue layer 27, a green layer 28 and a red layer 29—that are stacked on an antihalation layer 30. These four layers are typically stacked on a transparent base layer 31. In some applications, a developing chemical layer 26 may be applied to film 60.

Developing chemical layer 26 may also vary in thickness in the z direction between different points on the film, and may also affect the apparent density of the film. During a film development process, regions within the color-sensitive layer of the film that were exposed to the most light are the first to develop, and other regions develop as the development process continues. Those areas in which the most grains develop for a given layer will have the greatest density and lowest resultant pixel values. For example, images may contain areas of bright sky that contain many more grain traces than areas of low-light shadows. In addition, as film develops, it increases in density as silver is formed from compounds within the film, thus permitting latent images to be obtained by sensor 52.

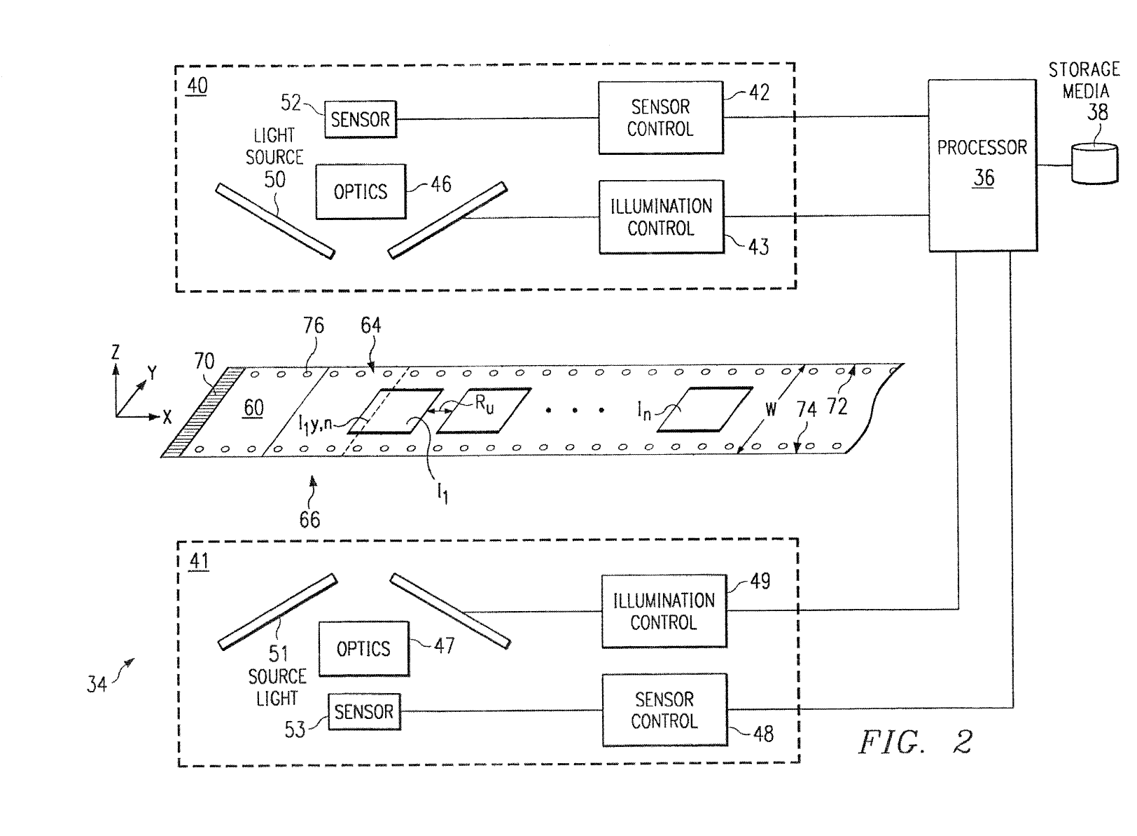

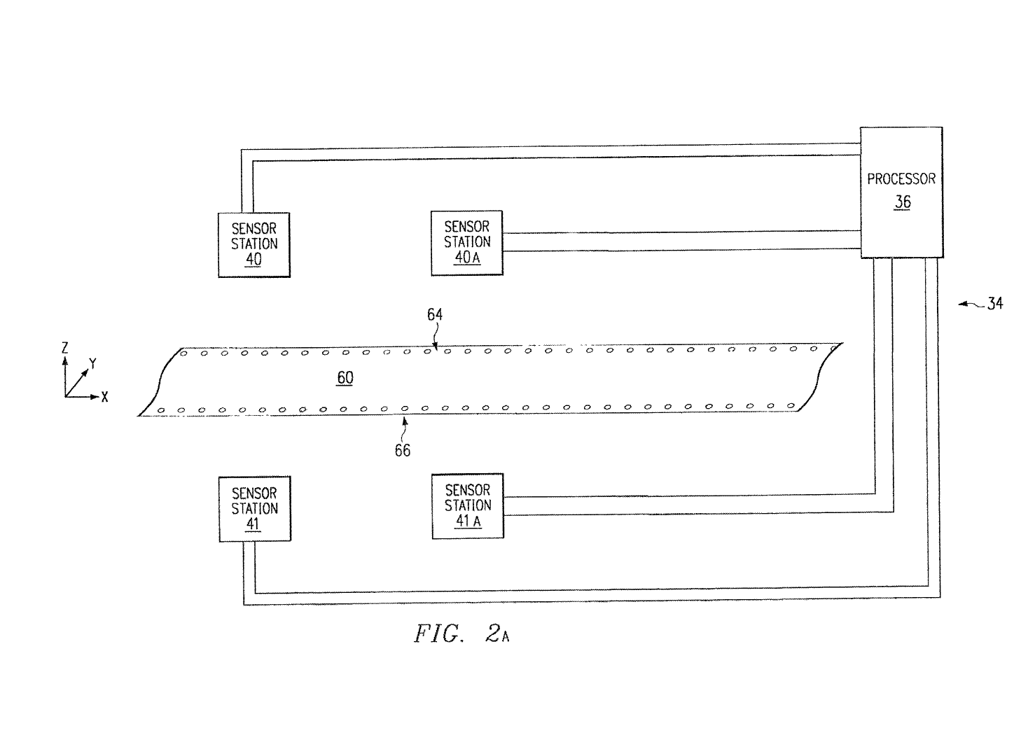

Sensor 52 is operable to measure light intensity within a spatial location of an image in film 60, even while film 60 is developing, or still has developing chemical applied thereto. These measurements may be obtained from silver formed from compounds within film 60, or from dyes within each of layers 27-29. Each intensity value associated with the intensity of light at that spatial location in the original image in film 60 corresponds to one of a series of pixels within an image as captured and/or stored by image capture engine 34 as illustrated in FIG. 2. The intensity refers generally to a pixel's brightness. For example, a white pixel has greater intensity values than a gray or black pixel. Thus, for pixels that comprise eight bits of resolution, a black pixel typically has an intensity value of close to zero, whereas a white pixel has an intensity value of close to 255. The range of light intensities within an image on film may be referred to as a dynamic range of the image. The use of white and dark pixels as used in this specification is not meant to impart any meaning to the content of image data. For example, white and dark pixels within a film negative would have the opposite meanings for a positive image print.

Each of these layers 26-31 modulate the light transmitted through and diffusely reflected by the film and thus affect the illumination levels measured by sensor 52. At least in part as a result, illumination levels measurable by sensor 52 may vary, depending on whether sensor 52 is disposed proximate to top portion 64 or bottom portion 66 of film 60 as illustrated in FIG. 1. In some applications, this may also result in saturation of sensor 52. Therefore, it may be desirable to adjust for these variations so that illumination levels measurable by sensor 52 more accurately reflect the values of image data. Two methods for performing such adjustments are discussed in conjunction with FIGS. 2 and 2A.

FIG. 2 illustrates an example of an image capture engine 34 that comprises an embodiment of the present invention. Image capture engine 34 may be a portion of digital film processing system 10 and comprises processor 36, storage medium 38 and sensor stations 40 and 41. Image capture engine 34 may also capture data from film 60, including a leader 70.

Sensor stations 40 and 41 may be used to capture image data from film 60 and may be similarly configured, operated and/or controlled. For example, similar to sensor station 40 as discussed in conjunction with FIG. 1, sensor station 41 may be disposed in a z direction proximate to, and may be moved at a scan rate relative to, film 60. Film 60 may also move through a plurality of orientations as both sensor stations 40 and 41 capture image data therefrom. Sensor stations 40 and 41 may also be disposed proximate to and oriented in various angles relative to film 60. Sensor station 41 comprises optics 47, light source 51, and sensor 53, and may also comprise its own sensor and illumination control 48 and 49. Alternatively, sensor station 41 may share sensor and illumination controls 42 and 43 with sensor station 40. In this embodiment, sensor station 40 may be located proximate to the top portion 64 of film 60, and sensor station 41 may be located proximate to bottom portion 66 of film 60. Sensors 52 and 53 operate in concert with light sources 50 and 51 and optics 46 and 47 to capture or obtain image data from film 60. Light sources 50 and 51 may utilize the same or different spectral wavelengths.

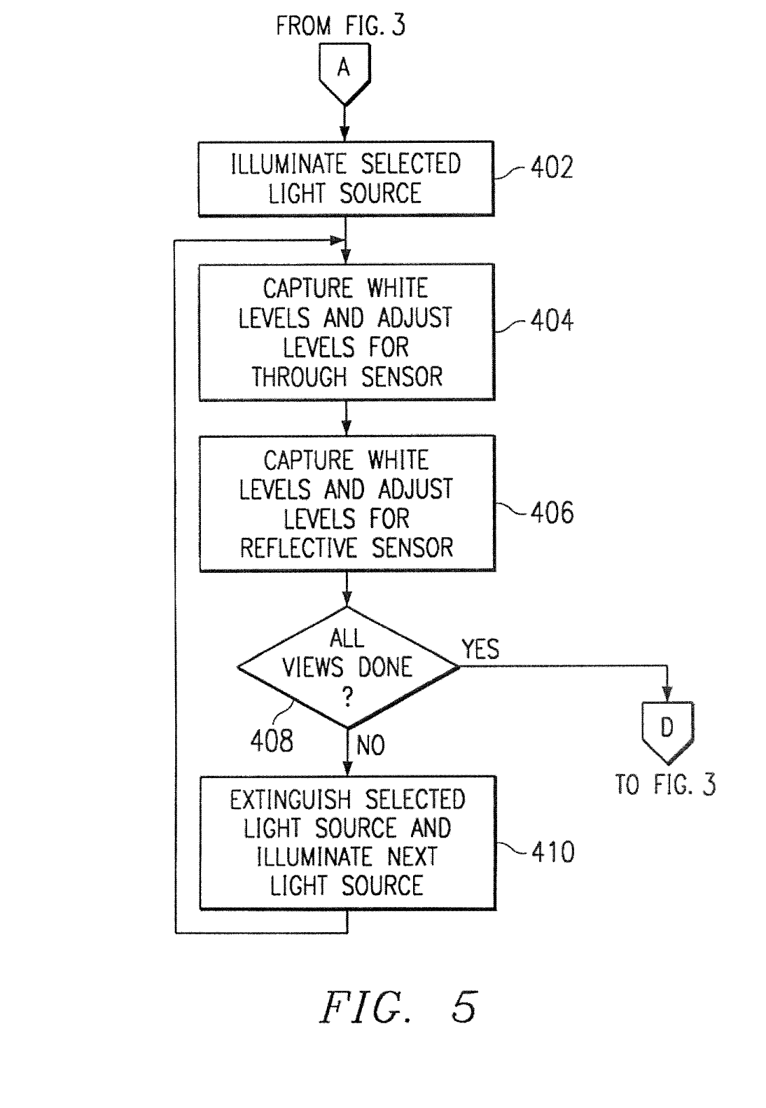

Sensor station 40 and sensor station 41 measure illumination levels through various incident angles of light reflected from and/or passed through film 60 to generate a resultant image. For example, sensor 52 may be used to capture light from light source 50 reflected from film 60 and/or light from light source 51 illuminated through film 60. Similarly, sensor 53 may be used to capture light from light source 51 reflected from film 60 and/or light from light source 50 illuminated through film 60. Each combination of a sensor and light source provides a unique sensor view that may be used to prevent sensor saturation and thus improve system dynamic range, as will be discussed in further detail in conjunction with FIG. 5. Image capture engine 34 may later adjust and combine the image data captured from one or more views by sensor stations 40 and/or 41 into various representations of one or more single images.

Processor 36 may control the operation of sensor stations 40 and 41 by using sensor controls 42 and 48 and/or illumination control 43 and 49. Alternatively or in addition, processor 36 may control sensor stations 40 and/or 41 by, for example, executing software that may be stored in storage medium 38. Also alternatively or in addition, processor 36 may comprise two individual processors. Each of these processors may control a respective sensor station.

To illustrate this aspect of the invention, each sensor may comprise a generally linear array operable to capture a data or image column over a generally linear field of view that spans width W (in the y direction) of film 60, or a portion thereof. For example, FIG. 2 illustrates a column I₁_{_{(y,n)}} that represents data that may be obtained from film 60 from one column in the y direction through image I₁ at row x-n. Film 60 is illustrated with a width W in the y direction measured between a top edge 72 and a bottom edge 74. Film 60 may comprise a single image frame II, or a plurality of image frames I₁-Iₙ disposed along the film in the x direction. Each image frame I₁-Iₙ may be the same or a different size. For example, image frame I₁ may be an image represented by a x b pixels, where a and b are any integer. That is, image I₁ includes a plurality of a pixels or columns in the x direction, and b pixels or rows in the y direction. For example, each image frame I₁-Iₙ may include 1024×1024 pixels, where a=b=1024. A plurality of image frames I₁-Iₙ is illustrated to discuss one aspect of the invention. In commercial films 60, each of these image frames I₁-Iₙ may be separated by an unexposed region Rᵤ. Some films 60 may also include one or more sprocket holes 76 and an area of unexposed film—the leader 70—which precedes a plurality of image frames I₁-Iₙ.

Image capture engine 34 may use leader 70 to obtain initial estimates of the density of film 60 and determine a high level for an initial system dynamic range. Unexposed film comprises a relatively uniform region of the highest light intensities and may be used to determine white levels. White levels as used in this specification may be defined as the highest pixel or signal value expected to be measured by a sensor. These estimates may be established by obtaining a plurality of readings within a region such as a column from leader 70, or obtaining substantially all data therefrom, whether or not a chemical developer has been applied. Image capture engine 34 may then initialize and/or adjust the sensor for illumination levels in response to these readings to prevent sensor saturation and thus improve system dynamic range. In some applications, image capture engine 34 may also perform these adjustments to accommodate for variations over time and/or due to changes in temperature. These adjustments may desirably prevent saturation of each sensor during capture of image data in image regions within film 60, because data within these image regions should fall within the dynamic range of the leader.

Similar to illumination control 43 as discussed in conjunction with FIG. 1, illumination control 49 may be used to control the amount of optical energy given off by light source 51, both in time and in amplitude. Illumination controls 43 and 49 may also comprise logic suitable to respond to readings from sensors 52 or 53 or prior readings such as amplitude and/or pulse width from light sources 50 and 51 respectively, and/or film characteristics. This logic may be software, hardware, or a combination thereof, and may be utilized to, for example, adjust an input current to a light source that accordingly adjusts an output optical energy, or illumination level. Illumination controls 43 and 49 may also comprise additional logic that is operable to accept pulse width control signals from processor 36 as desired. Alternatively or in addition, illumination controls 43 and 49 may comprise amplitude control logic, which may be software, hardware, or a combination thereof. The amplitude control logic may be responsive to a film type or an operating point, that may be input to or stored in a memory of illumination controls 43 and 49, and/or to signal amplitudes of sensors 52 and/or 53, respectively. Illumination controls 43 and 49 may also include additional circuitry used to interface the logic with light sources 50 and 51, respectively.

Sensor controls 42 and 48 may be used to control activation and deactivation of sensors 52 and 53 respectively, independently of or in conjunction with light sources 50 and 51. Sensors 52 and 53 may integrate over different intervals of time signals reflected from and transmitted through film 60 from light sources 50 and 51. Where a given illumination level may be desirable, each sensor 52 and 53 may integrate over a unique interval of time that may vary to capture varying amounts of illuminated power, depending on parameters such as dynamic range or a desired imaging window time. Image capture engine 34 may thus control a combination of illuminated power and sensor integration time as desired.

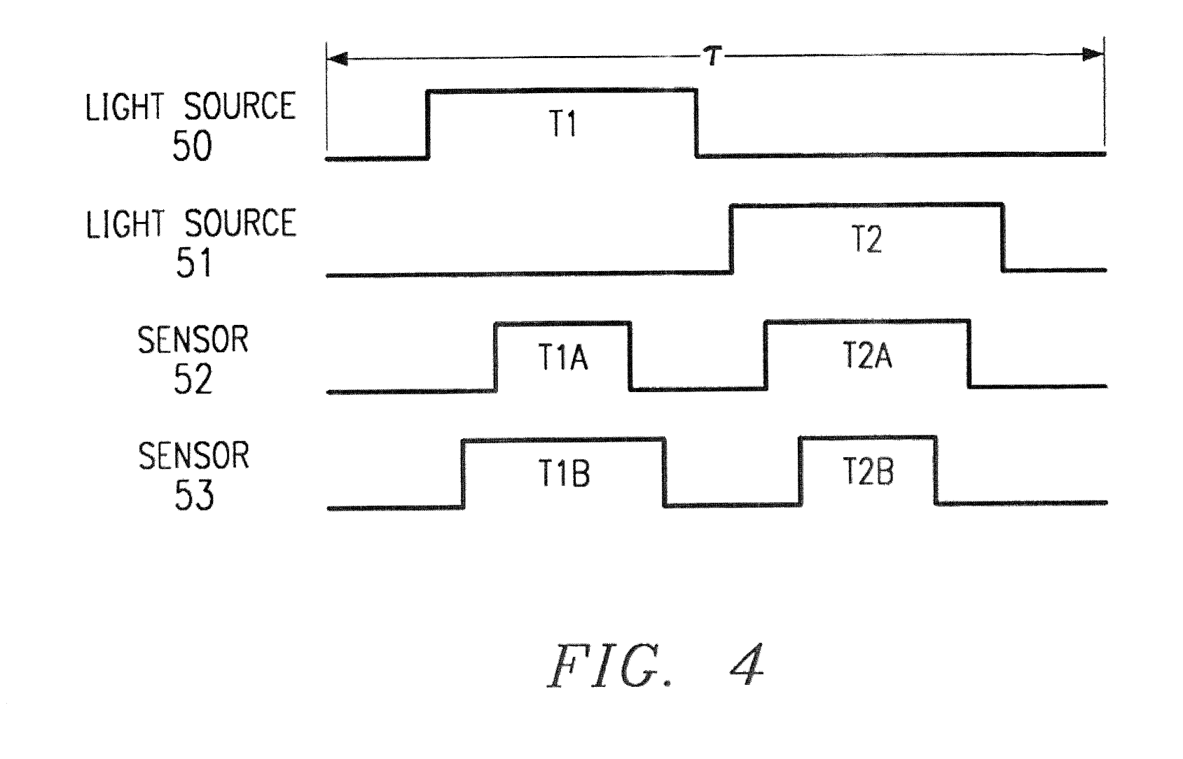

In operation, sensor station 40 obtains image data from film 60 and transfers the image data to a storage medium such as storage medium 38. Image capture engine 34 may prevent sensor saturation and improve system dynamic range by adjusting the pulse width and/or the output amplitude of light source 50 and/or 51, and/or the integration time of sensor 52 and/or 53. Generally, sensor integration time may be combined, and traded off, with a level of illumination power to obtain an effective illumination time or illumination level that may be captured by a sensor. For example, an increased effective illumination time may be obtained by either increasing sensor integration time at a given illumination power, or increasing the power of illumination at a given sensor integration time. Effective illumination time may be similarly decreased by decreasing sensor integration time or decreasing illuminated power under similar conditions. Thus, in applications where it may be desirable to capture images within a short time period, higher illumination levels may in some cases be used with a shorter sensor integration time. Similarly, where a given illumination level may be desirable, two different sensors such as sensors 52 and 53 may utilize different integration times to capture varying amounts of illuminated power. This provides the advantage of allowing the fall sensitivity of sensor stations to be used for each image while avoiding saturation of sensors 52 and 53, thus optimizing the dynamic range for each sensor. FIG. 4 graphically illustrates an imaging window during which sensor integration times and/or light source illumination levels may be adjusted.

Image capture engine 34 may also adjust image data after it has been captured. For example, image capture engine 34 may apply a gain in response to these illumination levels to desirably maximize the dynamic range of the image by mapping intensity values of each location to all usable pixel. Such an advantage may avoid sensor saturation and/or overflow in calculations used to produce the digital image, and facilitate matching the system dynamic range to the dynamic range of image data within film 60, thereby improving the quality of the resultant digital image.

FIG. 2A illustrates another example of an image capture engine that comprises an embodiment of the present invention. In this embodiment, image capture engine 34 may also be a portion of digital film processing system 10 and comprises sensor stations 40a and 41a in addition to sensor stations 40 and 41 to monitor the reaction of developing film at a plurality of development times for the film. These additional sensor stations may provide additional information with respect to variances in film characteristics as film 60 develops. Any number of additional sensor stations 40a and 41a may be used within the scope of the invention.

Sensor stations 40a and/or 41a may be disposed proximate to and at various intervals along the x direction of top portion 64 and bottom portion 66. Film 60 may move relative to these sensor stations at one or more scan rates where, for example, more than one transport mechanism may be used. Each sensor station may be controlled with a common processor 36, or may be controlled with its own processor (not explicitly shown). Image capture engine 34 may later adjust and combine the image data captured from the plurality of sensor stations 40 and/or 41 into various representations of one or more single images.

Image capture engine 34 is also operable to monitor and/or adjust illumination levels as described above. As film develops, its density increases and it captures more light as the density of silver increases. In some applications, image capture engine 34 may also utilize information provided by these other additional sensor stations to adjust illumination levels accordingly at various development times.

Within the scope of this invention, the architectures are envisioned, although not shown explicitly in FIGS. 2 and 2A. For example, there may be more than one light source 51 transmitting through the film v or 50 reflecting from the film in various combinations of visible and/or infrared spectral wavelengths. The plurality of light sources may be sequentially illuminated to capture the plurality of views with sensor 52. Alternatively, the sensor 52 could use a plurality of separately fitted columns in concert with the plurality of light sources 50 and/or 51 to capture the required views. It is understood that the timing diagram shown in FIG. 4 would require modification to support several of the envisioned architectural variations.

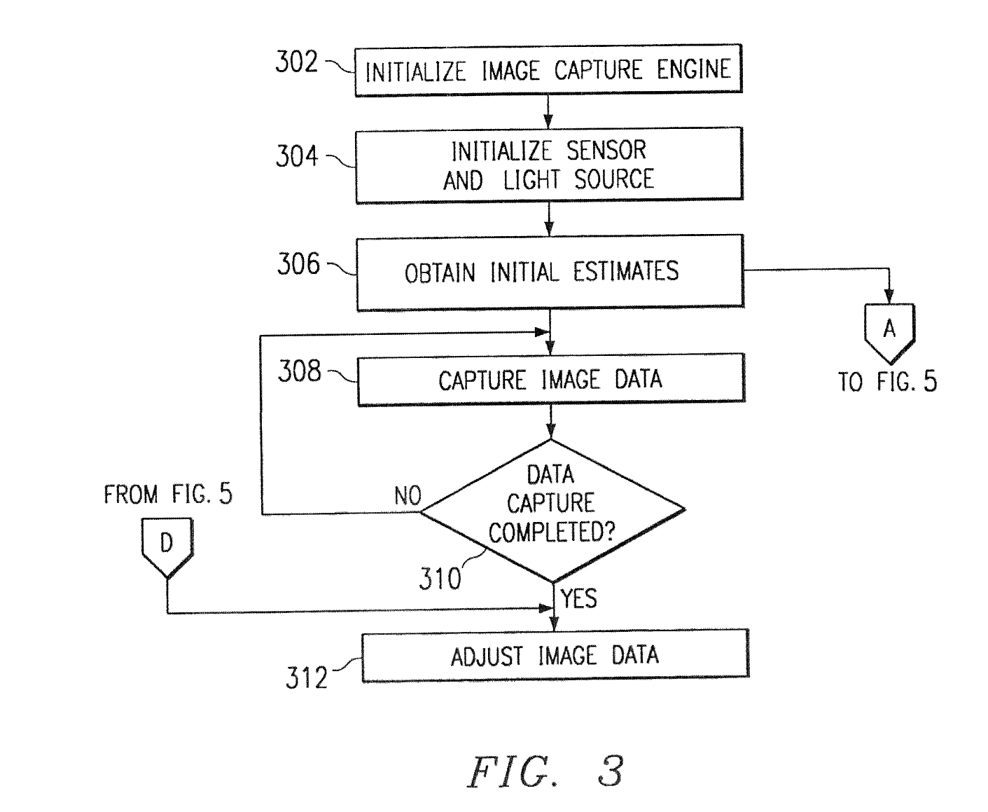

FIG. 3 illustrates an example of a method for capturing and adjusting image data in accordance with the present invention. While sensor stations 40 and 41 are used to illustrate this aspect of the invention, the method discussed in conjunction with this FIG. 3 may be used with any plurality of sensor stations and/or views. Image capture engine 34 may also selectively perform the method using some or all of these sensor stations and/or views as desired. Steps 302-312 comprise one embodiment of a method for obtaining and adjusting image data by image capture engine 34. Although steps 302-312 are illustrated as separate steps, various steps may be ordered in other logical or functional configurations, or may comprise single steps.

In step 302, each sensor station within image capture engine 34 may be optionally calibrated with some initial operating characteristics. Initializing sensor stations 40 and 41 may reduce variations in optical power over a period of time and/or due to temperature. For example, diodes within light sources 50 and 51 and detectors within sensor 52 and 53 generally produce thermal transients that follow an impulse upon activation, or turn-on, and decline approximately exponentially over a period of time substantially longer than a single pulse time. Therefore, it may be desirable to establish a stable operating point or level for each light source 50 and 51 and sensor 52 and 53 to reduce fluctuations in output power and sensitivity. Establishing an input operating point for each light source 50 and 51 in turn may stabilize the available signal strength that may be received by sensors 52 and 53, and may reduce the possibility that excess illumination may saturate these sensors. In other words, this may reduce fluctuations in the dynamic range of image capture engine 34. In one embodiment of the invention, image capture engine 34 may be stabilized by waiting a short period of time, for example, sixty seconds, in order for light sources 50 and 51 and sensors 52 and 53 to reach a nominal operating level. Such levels may be set automatically or manually.

In some applications, it may be desirable to avoid waiting for sensor stations 40 and 41 to adjust to equilibrium. In such a case, light sources 50 and 51 may be adjusted to compensate for illumination along a thermal transient output power decay curve while, for example, LED and/or CCD devices warm up. For example, an input current to a light source may be increased/decreased to stabilize its optical output power thereby keeping the image capture engine in a linear operating region. Sensors 52 and 53 may then be used to capture image data from film 60 while its responsivity is in a linear range with respect to the light source.

It may also be desirable to monitor and/or control operating current or power levels for such devices to ensure that image capture engine 34 is properly functioning. Such an advantage also may reduce processing time and maintenance costs, etc. For example, because the efficiency of devices such as LEDs or CCDs typically decrease as the devices age, their efficiency in achieving a desired power output typically declines over a long period of time (approximately the life span of the device). As a result, image capture engine 34 should occasionally adjust (typically increase) an input operating current (such as illumination amplitude or pulse width) or power level in order for the device to actually output a desired level of power.

One method for doing so includes image capture engine 34 capturing and storing within some non-volatile memory such as, e.g., storage medium 38 or ROM 36b, an operational level or operating point that is used to output the desired power level. Image capture engine 34 may store operating points as tables, variables, files, or in any other suitable arrangement. Image capture engine 34 may then access the non-volatile memory and use the operating points to activate the device at any time during the method. Saving and providing access to operating points as a device ages allows image capture engine 34 to adjust and change the operating points (and thus reach desired output power levels) as needed. Such an advantage may decrease thermal transients of, and initialization times for, the devices. Image capture engine 34 may also provide functionality to track a history of operating points for each device. This history may also be used to sound an alarm or send a message indicating that the device needs replacement. For example, image capture engine 34 may provide such functionality for each detector within sensors 52 and 53, and/or LEDs within light sources 50 and 51.

In step 304, image capture engine 34 initializes sensors 52 and 53 and/or light sources 50 and 51. In this step, image capture engine 34 may optionally adjust and/or set sensor and illumination levels for a film type. Initialization of one or both light sources 50 and/or 51 to a film type may avoid initial saturation of sensors 52 and 53. Initialization set points for film types may be stored in, for example, tables, variables, files, or in any other suitable arrangement in RAM 36a, ROM 36b, and/or storage medium 38, or may be manually chosen. If a type of film 60 is not known, then each of light sources 50 and/or 51 may be set to a nominal value, or a setting for a least dense film to be expected. In one embodiment of the invention, an initialization set point for such parameters may be automatically chosen if variation in film types is large. On the other hand, if variation between film types is small then some nominal set point may be chosen.

Image capture engine 34 may in step 306 use an unexposed region such as leader 70 to obtain initial estimates of the density of film 60 and white level readings. These estimates may be established by obtaining a plurality of readings within a region such as a column from leader 70, or obtaining substantially all data therefrom, whether or not a chemical developer has been applied. In addition, image capture engine 34 may adjust integration times of one or both sensors and/or illumination level of one or both light sources for the expected density of the film type.

In step 308, image capture engine 34 begins capturing data from film 60, by illuminating film 60 using light source 50 and capturing data with sensor 52. As previously discussed, image capture engine 34 may capture two-dimensional image data from film 60 by utilizing a two-dimensional sensor 52, such as a staring array. Alternatively, a generally linear array sensor 52 may obtain a data or image column along the y direction of film 60 as illustrated in FIG. 2. Film 60 may be moved at a scan rate relative to sensor 52 in the x direction as illustrated in FIG. 2 to obtain a two-dimensional plurality of columns for each latent image in film 60. If image data capture is not completed in step 310, image capture engine 34 returns to step 308 to continue. Alternatively, the invention also contemplates on-the-fly image data adjustment, where image capture engine 34 may adjust image data after some or all of the image data has been captured from film 60.

In step 312, image capture engine 34 may process and/or perform adjustments to image data captured using white levels obtained in step 306. Image capture engine 34 may adjust the dynamic range for the captured image data, which may avoid overflow in calculations. Processing may be performed as desired, including, but not limited to, a pixel, array (such as a data column), or image frame basis. Processing may also be performed in parallel or pipelined. Adjustment includes any alterations of pixel data in the captured image. To illustrate this aspect of the invention, adjustment is performed on image data captured in data columns by a generally linear sensor that comprises a plurality of detectors. All data including captured and/ or adjusted image data may be stored as pixel values representing the measured sensor illumination levels. These data may be stored in non-volatile memory such as storage medium 38 for subsequent processing, and/or stored in RAM 36a, ROM 36b, or in other storage media within image capture engine 34 for near-simultaneous processing.

To apply a gain level using the captured white level data, image capture engine 34 may optionally average the captured data for each detector within a sensor for several data columns within leader 70. Averaging or an equivalent thereto may reduce or eliminate other high frequency defects that may be due to external factors. Image capture engine 34 may use one of many methods to normalize these white levels—determine a new gain level—from the data captured from the unexposed region to achieve the effect of an approximately uniform instantaneous scan of film 60 across the detectors from each sensor.

Where a plurality of sensor stations are used, image data captured by each sensor station may be normalized independently. Such independent processing may be desirable, for example, where image capture engine 34 may utilize different parameters for each sensor station such as light sources using various wavelengths, and/or sensors with varying integration times. When a plurality of sensor stations are used, each representation of an image captured by a sensor station may be recombined and/or undergo other processing to form a single representation of the image. In addition, adjustments may be made at subsequent sensor stations using white levels captured from prior sensor stations to accommodate the changes in film density as film 60 develops.

Image capture engine 34 may perform adjustments as frequently as desired as discussed above, on image data captured or received by any image capture engine 34. Although one embodiment of an exemplary image capture engine 34 that may be used for image adjustment in connection with the invention has been illustrated, other image capture engines may be used without departing from the scope of the invention.

FIG. 4 graphically illustrates an example of an imaging window τ during which sensor integration times and/or light source illumination levels may be adjusted in accordance with the present invention. To illustrate this aspect of the invention, image capture engine 34 may capture image data during imaging window τ from film 60 by utilizing sensor stations 40 and 41. During imaging window τ, a two-dimensional sensor 52 may be used to capture image data from a two-dimensional region of film 60, and a generally linear array sensor 52 may obtain a data or image column along the y direction of film 60. At a next imaging window τ, sensor 52 may capture a next column of data from film 60, and repeat this process until all image data from film 60 has been captured. The first two waveforms illustrated in FIG. 4 represent activation periods for light sources 50 and 51, during which they typically emit a pulse of a desired amplitude level. Similarly, the third and fourth waveforms represent integration periods for sensors 52 and 53, during which time they are converting photons to electrons.

In operation, image capture engine 34 illuminates light source 50 for a period of time T1. Sensor 52 may be activated and capture light reflected from film 60 for a period of time T1A. Approximately simultaneously, sensor 53 may also be activated and capture image data for a period of time T1B as light from light source 50 is directed through film 60. Light source 50 may then be dimmed at the end of the period of time T1, and light source 51 may be illuminated for a period of time T2. Sensor 53 may be activated and capture light reflected from film 60 for a period of time T2B and approximately simultaneously, sensor 52 may be activated and capture light illuminated through film 60 for a period of time T2A. Alternatively, where light sources 50 and 51 utilize different spectral wavelengths, both light sources may remain illuminated through periods T1 and T2 provided sensors 52 and 53 have two or more columns of detectors which are uniquely sensitive to the independent wavelengths. As is discussed in further detail in conjunction with FIG. 5, period T1B may typically be larger than period T1A. For example, sensor 53 may integrate light directed through film 60 for a longer period without saturating than sensor 52 may integrate light reflected from film 60. Similarly, period T2A is typically larger than period T2B.

Image capture engine 34 may utilize a variety of methods to determine the durations of imaging window τ, and periods T1, T1A, T1B, T2, T2A, and T2B. For example, image capture engine 34 may determine the duration of such an imaging window τ to be a length of time sufficient to obtain a desired resolution at a desired scan rate, such as 12 μm. For example, if a square pixel is desired, optics 46 and a generally linear sensor 52 and/or 53 may be suitably adjusted to obtain data in the y direction of 12 μm. Then, image capture engine 34 may adjust the scan rate to obtain the desired resolution of 12 μm in the x direction.

Thus, imaging window τ may decrease as scan rate or pixel resolution size increases. Image capture engine 34 may also decrease imaging window τ by, for example, increasing the illuminated levels of light sources 50 and 51. Image capture engine may increase illumination levels by, for example, increasing an amplitude of light sources 50 and 51, or by increasing the pulse width of light sources 50 and 51. Increased illumination levels may in some applications be used with decreased sensor integration time, subject to the dynamic range adjustments described in conjunction with FIG. 5. Image capture engine 34 may also optionally accommodate additional time to perform additional processing by, for example, enlarging imaging window τ or decreasing one or more periods T1, T1A, T1B, T2, T2A, and/or T2B. Where one or more periods T1, T1A, T1B, T2, T2A, and/or T2B may be decreased, image capture engine 34 may increase the effective illumination power by, for example, increasing an amplitude of the pulses output by light sources 50 and 51.

FIG. 5 illustrates an example of a method for adjusting the system dynamic range in accordance with the present invention. In this embodiment, sensor stations 40 and 41 may be used to obtain four views of an image in film 60. A first view may be obtained by illuminating light source 50 and measuring energy levels within sensor 52 as it captures light reflected from film 60. Approximately simultaneously, sensor 53 may also capture image data as light from light source 50 is directed through film 60. Light source 50 may then be dimmed and light source 51 may be illuminated to obtain third and fourth views captured by light reflected from film 60 by sensor 53, and light illuminated through film 60 by sensor 52. White levels may also be captured for each of these four views, and be used for subsequent image data adjustment as discussed in conjunction with step 312.

The method begins in step 402, where image capture engine 34 activates light source 50, thus illuminating top portion 64 of film 60. Then in step 404, image capture engine 34 adjusts through sensor 53 to receive signals through film illuminated with light source 50. Image capture engine 34 activates sensor 53 and measures energy levels within sensor 53 as it captures light illuminated through film 60 for an integration time. Generally, where simultaneous or near-simultaneous captures of through and reflective views are used, a reflective sensor may measure higher signals than a through sensor, because a through sensor receives illumination through film 60, which decreases its signal levels. These energy or signal levels typically decrease with increases in density of film 60, thickness of developer, and the dark levels contained within a latent image frame.

Then, where simultaneous or near-simultaneous captures of through and reflective views are used, image capture engine 34 desirably adjusts the through sensor to measure signal levels just below saturation. Image capture engine 34 may perform the adjustment by controlling effective illumination levels, generally by one of three methods. Image capture engine 34 may adjust the pulse width for a light source, adjust the amplitude of the pulse for a light source, and/or adjust an integration time of the sensor. Image capture engine 34 then in step 406 adjusts the reflective sensor 52 accordingly to avoid saturation.

Image capture engine 34 may use any suitable combination of adjusting illumination levels and sensor integration times in steps 404 and 406. Generally, increased illumination levels may in some applications be used with decreased sensor integration time to achieve an effective illumination level, and vice versa. For example, it may be desirable to maintain the same illumination output level for light source 50 while adjusting sensor 52 where image capture engine 34 adjusts a pulse width or amplitude for light source 50 until the signal from sensor 53 just begins to saturate. In this case, image capture engine 34 may then slightly adjust the integration time for sensor 52 to measure just below saturation. Alternatively, image capture engine 34 may desire a specific duration for imaging window τ. In this case, image capture engine 34 may adjust an integration time for sensor 53 to measure just below saturation, and then adjust a pulse width or amplitude for light source 50 until the signal from sensor 52 just begins to saturate.

In step 408, image capture engine 34 determines whether all views have been established. If not, image capture engine 34 reverses the adjustment process for light source 51. For example, in step 410, image capture engine 34 dims light source 50 and illuminates light source 51. Image capture engine 34 returns to step 404 to measure levels for an integration time for sensor 52, the through sensor for light source 51. Image capture engine 34 may adjust the pulse width or amplitude for light source 51 and/or the integration time for sensor 52 until the signal from sensor 52 just begins to saturate. Image capture engine 34 may then slightly decrease the pulse width or amplitude for light source 51 so that sensor 52 measures just below saturation, and, in step 406, image capture engine 34 adjusts reflective sensor 53 to just below saturation.

The method also contemplates the use of any plurality of views. For example, one additional sensor may be used to create six views, and/or two additional sensors may be used to create eight views. It is also within the scope of the invention to use different numbers of views where a plurality of sensor stations is disposed in the x direction. The number of views may be selected automatically or manually, and may vary within image capture engine 34 as needed. Where more than one view is used, image capture engine 34 desirably obtains data from film 60 for all of the views within imaging window τ, as discussed in conjunction with FIG. 4. As another example, where six views are used, imaging window τ is desirably determined to accommodate suitable time for each sensor to capture data from each associated light source.

While the invention has been particularly shown by the foregoing detailed description, various changes, substitutions, and alterations may be readily ascertainable by those skilled in the art and may be made herein without departing from the spirit and scope of the present invention as defined by the following claims.

What is claimed is:

1. A digital film processing system, comprising:
a first light source operable to illuminate film;
a first sensor operable to produce a first output in response to a first amount of light reflected from the film for a first time interval;
a second sensor operable to produce a second output in response to a second amount of light passed through the film for the first time interval; and
processing circuitry coupled to the first light source and operable to adjust the output of the first light source in response to the first and second outputs so that the first sensor and the second sensor do not saturate.

2. The system of claim 1, wherein the processing circuitry is further operable to adjust image data obtained from the film in response to the first and second outputs.

3. The system of claim 1, wherein the processing circuitry is further operable to adjust the output of the first light source in response to a film type.

4. The system of claim 1, wherein the first amount of light is reflected from at least one unexposed region of the film and the second amount of light is passed through the at least one unexposed region of the film.

5. The system of claim 1, wherein the film has developing chemical applied thereto.

6. The system of claim 1, wherein the processing circuitry is further operable to save a last operating point of one of the group consisting of the first sensor and the first light source in a storage medium.

7. A method for digital film processing, comprising;
illuminating a film with a first light source;
producing a first output in response to a first amount of light reflected from the film with a first sensor for a first time interval;
producing a second output in response to a second amount of light passed through the film with a second sensor for the first time interval; and
adjusting the output of the first light source in response to the first and second outputs so that the first sensor and the second sensor do not saturate.

8. The method of claim 7, further comprising adjusting image data obtained from the film in response to the first and second outputs.

9. The method of claim 8, wherein the image data are adjusted in response to a gain level derived from the first and second outputs.

10. The method of claim 7, wherein the film has a developing chemical applied thereto.

11. The method of claim 7, wherein the first amount of light is reflected from at least one unexposed region of the film and the second amount of light is illuminated through the at least one unexposed region of the film.

12. The method of claim 7, further comprising adjusting the output of the first light source in response to a film type.

13. A system for developing and processing film comprising:
an applicator operable to coat a processing solution onto the film, the processing solution initiating development of the film;
a light source operable to illuminate the coated film with light;
a sensor operable to measure the light from the coated film; and
processing circuitry operable to vary an intensity of the light illuminating the coated film.

14. The system of claim 13, wherein the processing circuitry operates to vary the intensity of the light in response to a sensor measurement from an unexposed portion of the coated film.

15. The system of claim 14, wherein the film is substantially dry.

16. The system of claim 13, wherein the sensor is operable to measure light transmitted through the coated film.

17. The system of claim 13, wherein the sensor is operable to measure light reflected from the coated film.

18. The system of claim 17, wherein the light operates to produce infrared light.

19. The system of claim 17, wherein the light operates to produce visible light.

20. The system of claim 13, wherein the processing circuitry operates to vary the intensity of the light illuminating the coated film to substantially prevent saturation of the sensor.

21. The system of claim 13, wherein the processing circuitry operates to set the intensity of light for each frame of the coated film.

22. The system of claim 16, wherein the processing circuitry is further operable to adjust the output of the first light source in response to a film type.

23. The system of claim 16, wherein the light source operates to produce light within the visible portion of the electromagnetic spectrum.

24. The system of claim 16, wherein the light source operates to produce infrared light.

25. The system of claim 15, wherein the light source operates to produce visible light and infrared light.
